(19) United States
(12) Patent Application Publication
(10) Pub. No.: US 2004/0111630 A1
(43) Pub. Date: Jun. 10, 2004

(54) Method of preventing unauthorized use of virtual medium image file

(75) Inventors: Sang-Chul Hwang, Seoul City (KR); Sang-Jin Lee, Suwon City (KR); Jae-Ho Kim, Seoul City (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon City (KR)

(21) Appl. No.: 10/600,337

(22) Filed: Jun. 23, 2003

(30) Foreign Application Priority Data
Dec. 5, 2002 (KR) 2002-77062

(51) Int. Cl. G06F 12/14

(52) U.S. Cl. 713/193

(57) ABSTRACT

A method of preventing an unauthorized use of a virtual medium that replaces a physical medium, such as a computer stored virtual compact disc (CD) image file utilizing a virtual medium program, such as a virtual CD program, through which the virtual CD image file is read in a reproducible state. An identification of a computer is maintained by the virtual CD program when executing the virtual CD program. The maintained identification is stored in a downloaded virtual CD image file and the maintained identification is compared with the identification in the downloaded virtual CD image file upon being selected to be used, thereby controlling unauthorized use of the downloaded authorized virtual CD image file on another computer. For example, reproduction of a downloaded authorized virtual CD image file through the virtual CD program is interrupted if the two identifications do not match.

### CROSS-REFERENCE TO RELATED APPLICATIONS

This application claims the benefit of Korean Patent Application No. 2002-77062, filed Dec. 5, 2002, in the Korean Intellectual Property Office, the disclosure of which is incorporated herein by reference.

### BACKGROUND OF THE INVENTION

1. Field of the Invention

The present invention relates to a method of preventing an unauthorized use of a virtual medium, such as a compact/optical disc (CD) image file utilizing a virtual medium program, such as a virtual CD program through which a virtual CD image file stored in a computer system is read in a reproducible state.

2. Description of the Related Art

According to recent developments of relevant technologies enabling ultra high speed Internet services, it is typical that Internet users download data, such as software, programs, etc., into their computer systems through the Internet to use the downloaded data with their computers. However, in case of programs downloaded through the Internet in the form of files to be installed in the users' computers, some of the downloaded programs cannot be installed because they are designed to be executed only under a condition that original CDs, as in the case of common game titles, have been inserted into the CD-ROM (CD-Read Only Memory) drive. To overcome this shortcoming, a virtual CD program has been supplied, under which software, such as the game titles, are provided in an image form of an original CD (i.e., a virtual CD or a CD image file) to be used with the virtual CD program. Therefore, the virtual CD can be downloaded through the Internet into the user's computer, and then installed and executed using the virtual CD program without using the original (physical) CD.

The virtual CD program refers to software wherein a virtual CD-ROM drive in the manner of software that replaces a physical CD-ROM drive is made within a space also occupied by a hard disk of the computer system and all information contained in a relevant CD-ROM is stored in the virtual CD-ROM drive as an image file (i.e., as a virtual CD), and then, the virtual CD is allowed to be read and executed without the physical CD-ROM drive and the physical CD. The image file (virtual CD) stored in the virtual CD-ROM drive allows all data and information contained in a physical CD-ROM to exist in a form of files in the hard disk of the computer system, comprising a header part containing basic information necessary for operating the virtual CD-ROM drive and a portion containing the data and information of the CD-ROM.

To describe a process of downloading the CD image file and executing it in a user's computer system, the user through the Internet accesses a server storing therein the CD image file which the user would like to download, and enters a user ID and password as agreed with the provider of the server in advance. Through this operation, the user is authenticated, entitling the user to download the user's desired CD image file. The user downloads the desired CD image file from the server into the user's computer system and executes a virtual CD program to use the downloaded CD image file.

However, this conventional method cannot prevent another user from copying and using, without authorization, the CD image file (i.e., the virtual CD) previously downloaded by an authorized user, thereby being unable to prevent an unauthorized use of the previously downloaded authorized virtual CD.

### SUMMARY OF THE INVENTION

Accordingly, the present invention provides a method of preventing an unauthorized use of a virtual CD image file wherein the virtual CD image file downloaded online can be neither reproduced nor used with another computer system without authorization.

Additional aspects and advantages of the invention will be set forth in part in the description which follows and, in part, will be obvious from the description, or may be learned by practice of the invention.

The present invention is achieved by providing a method of preventing an unauthorized use of a virtual CD image file utilizing a virtual CD program through which the virtual CD image file stored in a computer is read in a reproducible state, comprising temporarily storing identification number of a user computer within the virtual CD program when the virtual CD program is executed; accessing a server supplying a predetermined virtual CD image file through the user computer; allowing a user to download the virtual CD image file supplied from the sever into the user computer; storing the identification number temporarily stored within the virtual CD program in a downloaded virtual CD image file; comparing the identification number temporarily stored within the virtual CD program with the identification number stored in the virtual CD image file when the virtual CD image file is selected to be reproduced; and interrupting reading the virtual CD image file through the virtual CD program if the two identification numbers are not identical.

According to an aspect of the invention, the identification number of the user computer is read from a CMOS-RAM of the user computer and temporarily stored within the virtual CD program during execution.

According to an aspect of the invention, an FTP module within the virtual CD program accesses the server allowing the user to download the virtual CD image file.

According to an aspect of the invention, allowing the user to download the virtual CD image file further comprises requesting the user to enter a certain number for authentication as to whether the user is authorized to use the virtual CD image file when downloading the virtual CD image file.

According to an aspect of the invention, the method further comprises receiving a CD key transmitted from the server, the CD key being required for using the downloaded virtual CD image file.

The present invention may be also achieved by providing a method of preventing an unauthorized use of a virtual CD image file utilizing a virtual CD program through which the virtual CD image file stored in a computer is read in a reproducible state, comprising storing identification number of a user computer in a space within the user computer as designated by the virtual CD program when the virtual CD program is installed; accessing a server supplying a predetermined virtual CD image file through the user computer; allowing a user to download the virtual CD image file supplied from the sever into the user computer; storing the identification number stored in the user computer in the downloaded virtual CD image file; comparing the identification number stored in the user computer with the identification number stored in the virtual CD image file when the virtual CD image file is selected to be reproduced; and interrupting reading the virtual CD image file through the virtual CD program if the two identification numbers are not identical.

According to an aspect of the invention, the identification number of the user computer is read from a CMOS-RAM of the user computer and stored in the user computer.

According to an aspect of the invention, an FTP module within the virtual CD program is used to access the server allowing the user to download the virtual CD image file.

According to an aspect of the invention, allowing the user to download the virtual CD image file further comprises requesting the user to enter a certain number for authentication as to whether the user is authorized to use the virtual CD image file when downloading the virtual CD image file.

According to an aspect of the invention, the method further comprises receiving a CD key transmitted from the server, the CD key being required for using the downloaded virtual CD image file.

### BRIEF DESCRIPTION OF THE DRAWINGS

The above and/or other aspects and advantages of the present invention will become apparent and more readily appreciated from the following description of the embodiments, taken in conjunction with the accompanying drawings of which:

FIG. 1 is a functional block diagram of a system preventing an unauthorized use of a virtual CD image file, according to an embodiment of the present invention;

FIG. 2 is a flow chart of preventing an unauthorized use of a virtual CD image file using the system shown in FIG. 1, according to an embodiment of the present invention; and

FIG. 3 is a flow chart of preventing an unauthorized use of a virtual CD image file using the system shown in FIG. 1, according to another embodiment of the present invention.

### DETAILED DESCRIPTION OF THE PREFERRED EMBODIMENTS

Reference will now be made in detail to the embodiments of the present invention, examples of which are illustrated in the accompanying drawings, wherein like reference numerals refer to like elements throughout. The embodiments are described below in order to explain the present invention by referring to the figures.

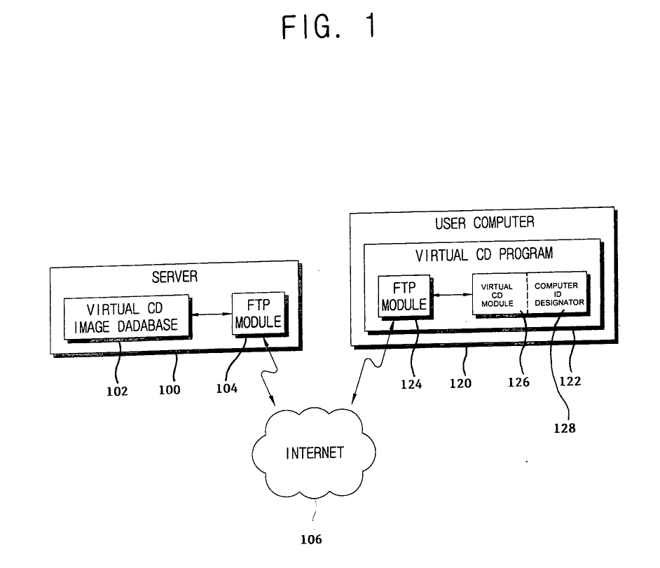

FIG. 1 is a functional block diagram of a system preventing an unauthorized use of a virtual CD image file, according to an embodiment of the present invention. Referring to this figure, a system preventing an unauthorized use of the virtual CD image file comprises a user computer 120 on which a virtual CD program 122 is installed and a server 100 having therein a virtual CD image database 102.

The virtual CD program 122 comprises a virtual CD module 126 wherein a virtual CD-ROM drive, which is in the form of software replacing a physical CD-ROM drive, is provided within a hard disk of the computer system and all information typically contained in the physical CD-ROM is stored in the hard disk as an image file providing a virtual CD. The virtual CD module 126 allows the virtual CD to be read and executed without the physical CD.

The virtual CD program 122 further comprises a computing device ID designator 128 that maintains an identification designation (ID) corresponding to the user computer 120 (i.e., a computer/device ID). For example, the computer ID designator 128 reads an identification number of the user computer 120 whenever the program 122 is executed, and temporarily stores the read identification number within the virtual CD program 122. Meanwhile, as another embodiment of the present invention, the read identification number may be stored in a registry within the user computer 120 as designated by the virtual CD program 122 at the time of installing the program 122.

The virtual CD program 122 also comprises an FTP module 124 with which the user computer 120 is allowed to access the server 100 via a network, such as the Internet 106, and download a virtual CD image file stored in the virtual CD image database 102 of the server 100. The computer ID designator 128 stores the computer identification number, which has been temporarily stored within the virtual CD program 122, in a header of the virtual CD image file downloaded. As another embodiment of the present invention, the computer identification number stored in the registry of the user computer 120 may be stored in the virtual CD image file.

Additionally, the computer ID designator 128 has a function of comparing either the computer identification number temporarily stored within the virtual CD program 122 or the computer identification number stored in the registry of the user computer 120 as designated by the virtual CD program 122 with the computer identification number stored in the virtual CD image file and reading the downloaded virtual CD image file only when the two identification numbers match (i.e., the identification number corresponding to the user computer 120 matches the computer identification number stored in the virtual CD image file).

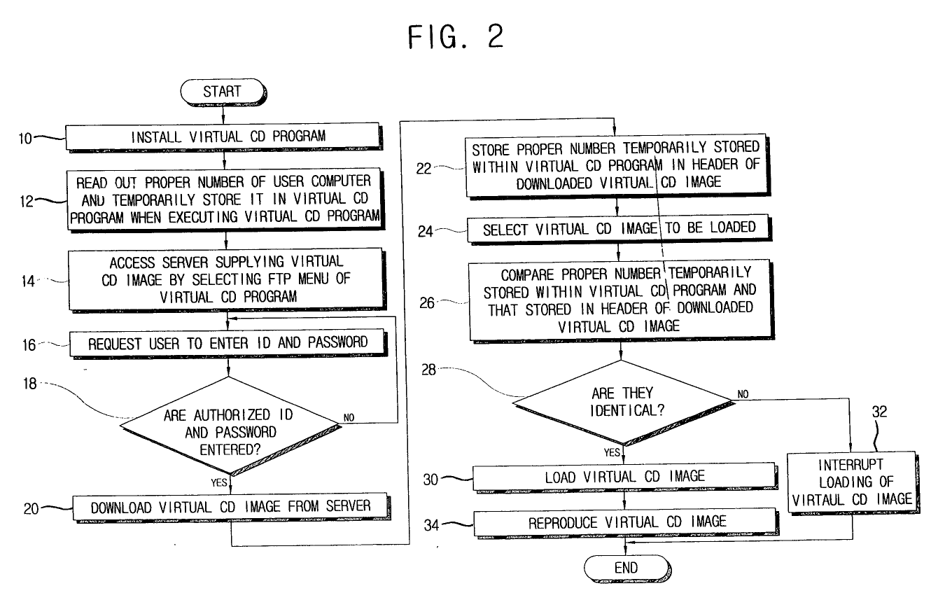

FIG. 2 shows a flow chart of preventing an unauthorized use of a virtual CD image file using the system shown in FIG. 1, according to an embodiment of the present invention. At operation 10, a user establishes in a computing device, such as the user computer 120, a directory in which a virtual CD image file will be stored, and installs the virtual CD program 122 through processes of selecting registration of a start-up program and installing a virtual CD-ROM drive. Typically, at operation 12, when a user executes the virtual CD program 122, the virtual CD program 122 encodes an identification number (ID), which is tied to the downloading computing device, and read and/or generated by the computer ID designator 128 (i.e., a computer/device identification information), such as ID of a CPU and the like read from a CMOS-RAM of the user computer 120. Further, at operation 12, the encoded computer identification number is temporarily stored in a parameter within the virtual CD program 122. In particular, the computer ID designator 128 performs operation 12. Here, since the computer identification number is temporarily stored, the stored computer identification number will disappear (i.e., deleted/erased) when the virtual CD program 122 is completed (i.e., closed/shutdown). That is, whenever the virtual CD program 122 is executed, a process of designating the identification number of the user computer 120 is repeated, and accordingly, a process of authenticating the computer identification number is performed whenever the program 122 is executed.

At operation 14, after selecting an FTP menu of the virtual CD program 122, the user computer 120 accesses, via the Internet 106, the server 100 supplying (providing) a predetermined (e.g., a user selected) virtual CD image file, for example, a game software, etc. When an access to the server 100 is made, at operation 16, the server 100 requests the user to enter a user ID and password and, at operation 18, determines whether the ID and password entered by the user match (e.g., are identical to) the ID and password stored in the server 100. If both IDs and passwords are identical, the user computer 120 is allowed to access the server 100. After operation 18, if, at operation 20, the user selects a virtual CD image file, the server 100 reads a selected CD image file from the virtual CD image database 102. In particular, at operation 20, a user-selected and server-read CD image file is downloaded into the user computer 120 by driving the FTP module 124 of the virtual CD program 122. Then, at operation 22, the computer identification number temporarily stored in the parameter within the virtual CD program 122 is stored in a header of the downloaded virtual CD image file. In particular, the computer ID designator 128 performs operation 22. Thereafter, typically the user interrupts the FTP connection of the virtual CD program 122.

If, at operation 24, a downloaded virtual CD image file is selected to be loaded (e.g., executed, played, etc.), at operation 26, the virtual CD program 122, via the computer ID designator 128, compares the computer identification number stored in the header of the selected downloaded virtual CD image file with the computer identification number temporarily stored within the virtual CD program 122 and, at operation 28 determines whether they match (e.g., are identical). In particular, if, at operation 28, an identification number, which is tied to a downloading computing device, and read and/or generated by the computer ID designator 128, for example, a CPU ID, matches the computer identification number stored in the selected downloaded virtual CD image file as a result of comparison, at operation 30, the selected downloaded CD image file is made available for loading (i.e., made accessible). That is, at operation 30, the selected downloaded virtual CD image file is inserted into the virtual CD-ROM drive, whereby it is possible to use data of the selected downloaded CD image file, for example, by installing software within the image file or, for example, at operation 34, by using, such as playing (reproducing), the data of the image file.

On the other hand, if, at operation 28, the two identification numbers do not match as a result of comparison, at operation 32, loading of the selected downloaded CD image file is interrupted. Accordingly, if another user tries to copy and use the previously downloaded authorized CD image file without authorization at another computing device, loading of the previously downloaded authorized virtual CD image file is not performed, because the computer identification number stored in the previously downloaded authorized CD image file differs from the identification number corresponding to the other user's computer (i.e., the identification number of the other user's computer differs from the computer identification number of the authorized user computer 120 having first downloaded and used the CD image file). Accordingly, the present invention prevents an unauthorized copying and use of the virtual CD image file.

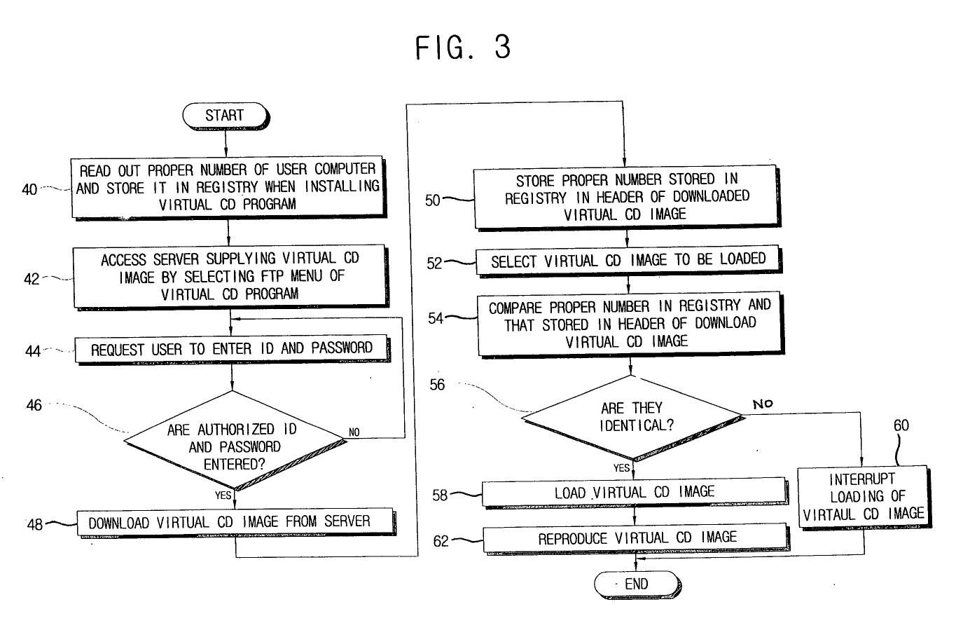

FIG. 3 is a flow chart of another embodiment of the present invention in which the identification number of the user computer 120 may be stored in a registry of a computing device, such as the user computer 120, as designated by the virtual CD program 122, via the computer ID designator 128, at the time of installing the virtual CD program 122. As shown in FIG. 3, at operation 40, the virtual CD program 122 encodes an identification number, which is tied to the downloading computing device, and read and/or generated by the computer ID designator 128 (i.e., a computer identification information), such as the identification number of a CPU and so on read from a CMOS-RAM. The encoded computer identification information is stored in the registry of the user computer 120 as designated by the virtual CD program 122 at the time of installing the program 122. At operation 42, the user executes the virtual CD program 122 to download a virtual CD image file from the server 100. The operations 42 through 48, selecting and downloading the CD image file, are identical to operations 14 through 20 of FIG. 2, and therefore, a description thereof will be omitted herein.

At operation 50, the computer identification number stored in the registry designated by the virtual CD program 122 is stored in a header of the downloaded virtual CD image file. In particular, the computer ID designator 128 performs operation 50. Then, typically, the user interrupts the FTP connection of the virtual CD program 122.

If, at operation 52, a downloaded virtual CD image file is selected to be loaded (e.g., executed, played, etc.), at operation 54 the virtual CD program 122, via the computer ID designator 128, compares the computer identification number stored in the header of the selected downloaded virtual CD image file with the computer identification number stored in the registry and, at operation 56, determines whether they match (e.g., are identical). In particular, if, at operation 56, an identification number, which is tied to a downloading computing device, and read and/or generated by the computer ID designator 128, for example, a CPU ID, matches the computer identification number stored in the selected downloaded virtual CD image file as a result of comparison, at operation 58, the selected downloaded virtual CD image file becomes available for loading (i.e., made accessible). For example, at operation 62 it is possible to reproduce the selected downloaded virtual CD image file. But, if at operation 56, the two identification numbers do not match as a result of comparison, at operation 60, loading of the selected downloaded virtual CD image file is interrupted. Accordingly, if an unauthorized user attempts to copy and use in another computer the previously downloaded authorized virtual CD image file, in which the computer identification number of the authorized user computer 120 is stored, such an unauthorized use is not allowed.

In the above described embodiment the user computer 120 accesses the server 100 supplying virtual CD image files through an FTP menu within the virtual CD program 122. However, the server 100 may be accessed by other FTP program(s) in communication/interfaced with the virtual CD program 122. In the above described embodiment, the virtual CD program 122 may further comprise an operation of receiving a CD key transmitted from the server 100 if the CD key is required for using the downloaded virtual CD image file.

According to the configuration of the present invention, an illegal copying and use of a downloaded authorized virtual CD image file from the server 100 by an unauthorized user can be prevented by storing an identification designation corresponding to the authorized user computer 120 in the downloaded authorized virtual CD image file and allowing the authorized virtual CD image file to be only driven in the user computer 120 having the matching computer identification designation at the time of the downloading of the virtual CD image file. As described above, the present invention has provided a method of preventing an illegal use of a downloaded authorized virtual CD image file wherein copying and use of the downloaded virtual CD image file on another computing device without authorization can be prevented.

In particular, an identification of a virtual CD image processing device (virtual CD device) is maintained by a virtual CD program upon executing the virtual CD program. The identification maintained by the virtual CD program is stored in a virtual CD image file downloaded via a network, such as the Internet, and the maintained identification is compared with the identification stored in the downloaded virtual CD image file when the downloaded virtual CD image file is selected to be used, thereby controlling unauthorized use of the selected downloaded authorized virtual CD image file on another computer. For example, reproduction of a downloaded authorized CD image file through the virtual CD program is interrupted if a device identification (i.e., a virtual CD program identification) and the downloaded CD image file identification do not match. The processes of the present invention as embodied in the computer ID designator 128 can be implemented in software and/or hardware. Further, although an example embodiment is described in which the processes of the present invention are implemented as a programming module named the computer ID designator 128 within the virtual CD program 122, the present invention is not limited to such configuration, and processes of the invention can be implemented as otherwise integrated with or in communication (interfaced) with any virtual CD program 122. Further, although the example embodiments use a virtual compact/optical disc, the present invention is not limited to such configuration and the present invention can be achieved in connection with any virtual medium configuration to replace a physical medium utilizing a virtual medium file and a virtual medium program.

Accordingly, the present invention provides a downloading computing device (apparatus), such as a computer, a personal digital assistant, etc., that processes virtual CDs (i.e., executes a virtual CD program to process a virtual CD, thereby providing a virtual CD device), requiring a virtual CD accessible state tied to the virtual CD and the downloading computing device at a downloading time of the virtual CD, and only allowing access to the virtual CD according to the accessible state, and a method thereof. Further, the present invention is directed to a computing device protecting a downloaded authorized virtual CD image file by tying the downloaded authorized virtual CD image file to the computing device downloading the virtual CD image file. For example, an ID identifying a downloading computing device, such as an existing or generated device ID, etc., is maintained by the computing device (e.g., generated, read/retrieved, stored in a register or other nonvolatile storage associated with the device) and assigned to a downloaded virtual CD image file and the computing device is programmed to allow access to the downloaded virtual CD image file only in response to a match between the virtual CD image file ID and the corresponding device ID (i.e., to allow access in an accessible state, such as a reproducible state, tied to a virtual CD image file and a virtual CD program as a virtual CD device that downloaded the virtual CD image file). Typically, a computing device of the invention, which an be referred to as a virtual CD device, comprises a data storage, such as magnetic and optical discs, RAM, ROM, etc., on which the processes of the invention can be stored as software and executed to control the computing device according to the invention.

Although a few embodiments of the present invention have been shown and described, it will be appreciated by those skilled in the art that changes may be made in these embodiments without departing from the principles and spirit of the invention, the scope of which is defined in the appended claims and their equivalents.

What is claimed is:

1. A method of preventing an unauthorized use of a virtual compact disc (CD) image file utilizing a virtual CD program through which the virtual CD image file stored in a computer is read in a reproducible state, comprising:
temporarily storing an identification of a user computer within the virtual CD program when the virtual CD program is executed;
accessing a server supplying a predetermined virtual CD image file through the user computer;
allowing the user to download the virtual CD image file supplied from the sever into the user computer;
storing the identification temporarily stored within the virtual CD program in the downloaded virtual CD image file;
comparing the identification temporarily stored within the virtual CD program with the identification stored in the virtual CD image file when the downloaded virtual CD image file is selected to be reproduced; and
interrupting reading the selected downloaded virtual CD image file through the virtual CD program if the two identifications do not match.

2. The method according to claim 1, wherein the temporarily stored identification is read from a CMOS-RAM of the user computer.

3. The method according to claim 1, wherein the user downloads the virtual CD image file by driving a file transfer protocol (FTP) module within the virtual CD program.

4. The method according to claim 1, wherein the temporarily stored identification is a central processing unit (CPU) number.

5. The method according to claim 1, wherein the allowing of the user to download the virtual CD image file further comprises requesting the user to enter an authentication number to determine whether the user is authorized to use the virtual CD image file when downloading the virtual CD image file.

6. The method according to claim 1, further comprising receiving a CD key transmitted from the server, the CD key being required for using the downloaded virtual CD image file.

7. A method of preventing an unauthorized use of a virtual compact disc (CD) image file utilizing a virtual CD program through which the virtual CD image file stored in a computer is read in a reproducible state, comprising:
storing an identification of a user computer in a predetermined register within the user computer as designated by the virtual CD program when the virtual CD program is installed;
accessing a server supplying a predetermined virtual CD image file through the user computer;
allowing the user to download the virtual CD image file supplied from the sever into the user computer;
storing the identification stored in the registry of the user computer in the downloaded virtual CD image file;
comparing the identification stored in the registry of the user computer with the identification stored in the downloaded virtual CD image file when the downloaded virtual CD image file is selected to be reproduced; and
interrupting reading the selected downloaded virtual CD image file through the virtual CD program if the two identifications do not match.

8. The method according to claim 7, wherein the identification stored in the registry is read from a CMOS-RAM of the user computer.

9. The method according to claim 7, wherein the user downloads the virtual CD image file by driving a file transfer protocol (FTP) module within the virtual CD program.

10. The method according to claim 7, wherein the identification stored in the registry is a central processing unit (CPU) number.

11. The method according to claim 7, wherein the allowing of the user to download the virtual CD image file comprises requesting the user to enter an authentication number to determine whether the user is authorized to use the virtual CD image file when downloading the virtual CD image file.

12. The method according to claim 7, further comprising receiving a CD key transmitted from the server, the CD key being required for using the downloaded virtual CD image file.

13. A networked virtual CD device, comprising:
a programmed computer processor requiring a virtual CD accessible state tied to the virtual CD and the virtual CD device at a downloading time of the virtual CD, and allowing access to the virtual CD according to the accessible state.

14. The device of claim 13, wherein the programmed computer processor further maintains an identification corresponding to the downloading virtual CD device, stores the maintained identification in the downloaded virtual CD during the downloading, and in response to an access to the downloaded virtual CD, determines the accessible state according to a match between the maintained identification and the identification of the downloaded virtual CD.

15. A method, comprising:
requiring a virtual CD accessible state tied to the virtual CD and a downloading virtual CD device downloading the virtual CD; and
allowing access to the virtual CD according to the accessible state.

16. A computer readable storage controlling a virtual medium device according to a process of:
storing an identification corresponding to the virtual medium device in a downloading authorized virtual medium image file; and
allowing the authorized virtual medium image file to be only driven in the virtual medium device having the identification during the downloading of the virtual medium image file.
